(19) United States
(12) Patent Application Publication
(10) Pub. No.: US 2003/0134109 A1
(43) Pub. Date: Jul. 17, 2003

(54) Rubber/thermoplastic grip tape for handle

(76) Inventors: Sam H. Chen, San Diego, CA (US); C. F. Chang, Taichung (TW)

Correspondence Address: CALIF KIP TERVO, 6387 CAMINITO LAZARO, SAN DIEGO, CA, 92111, US

(21) Appl. No.: 10/047,387

(22) Filed: Jan. 16, 2002

(51) Int. Cl. B32B 7/12; B32B 5/02; B32B 15/04; B32B 13/02

(52) U.S. Cl. 428/343; 428/304.4; 442/327; 442/386

(57) ABSTRACT

A grip tape 10 for wrapping a handle 94 such as of a golf club 90 generally comprises a top portion 19 comprising an elongate strip of rubber 70 and an elongate thermoplastic portion 20 including a thermoplastic 41 such as polyurethane 42, and a bottom portion 80 of cloth 82, such as felt 83, bonded to top portion 19. Rubber 70 includes a central portion 73, a right edge portion 75, and a left edge portion 77. The thermoplastic portion 20 includes a central portion 25, a right edge embossed portion 27, and a left edge embossed portion 36. Embossed portions 27, 36 are denser than central portion 25 and stiffer than rubber edge portions 75, 77. Left edge embossed portion 36 overlaps rubber right edge portion 75 and is bonded thereto. Tape 10 is spiral wrapped around handle 94 such that right edge embossed portion 27 overlies rubber left edge portion 77 of the previous turn.

### FIELD OF THE INVENTION

This invention relates in general to an improved grip tape for the handle of a racquet, golf club, or other device that is subject to shock when the device is impacted, such as a hammer, golf club, or baseball bat, and more specifically to a grip tape including grip surfaces of rubber and thermoplastic, such as polyurethane.

### BACKGROUND OF THE INVENTION

Grip tape for wrapping a handle to enhance grip and/or to reduce shock is well-known. Various materials have been used to wrap a handle, including a rubber strip and polyurethane.

Rubber provides cushioning and has a good grip surface which is easily enhanced with surface features such as grooves or protrusion. Importantly, rubber is very durable and resists abrasion. Thus, it has a long life. Rubber does not deform so that it maintains the dimensions of the grip over time. Rubber is easily kept dry with surface chemicals. Rubber tape peels or curls up along the edges.

Polyurethane typically is more shock absorbing than rubber, more comfortable than rubber and has a tackier surface for better grip. However, polyurethane is less durable than rubber and deform with use such that the grip dimensions change. With small amounts of water, polyurethane may be kept dryer than rubber and thus be less slippery, but with large amounts of water, rubber may be kept dry more easily and, thus, may provide better grip. Polyurethane may be made stiff along the edges so as to not peel up during use.

It would be desirable to produce a grip tape that utilizes the desirable characteristics of rubber and polyurethane without the major drawbacks.

### SUMMARY OF THE INVENTION

This invention is a grip tape for wrapping a handle. The tape has a top, a bottom, a left side, and a right side. The tape generally comprises a top portion comprising an elongate rubber strip and an elongate thermoplastic strip and a bottom portion of cloth, such as felt, bonded to the top portion. The bottom is bonded to two-sided tape.

Rubber has right edge and a left edge and rubber comprises a central portion having an upper surface, a right edge portion having an upper surface lower than the rubber central portion upper surface, and a left edge portion having an upper surface lower than the rubber central portion upper surface.

The thermoplastic portion has a right edge and a left edge and comprises an upper part of thermoplastic, and a lower part of cloth bonded to the thermoplastic. The thermoplastic portion includes a central portion having an upper surface, a right edge embossed portion having an upper surface lower than the thermoplastic portion central portion upper surface, the right edge embossed portion being denser than the thermoplastic portion central portion, and a left edge embossed portion having an upper surface lower than the thermoplastic portion central portion upper surface, the left edge embossed portion being denser than the thermoplastic portion central portion. The left edge embossed portion overlaps the rubber right edge portion to define an overlap and is bonded to the rubber right edge portion. Preferably, the thermoplastic portion left edge has an upper surface lower than the rubber central portion upper surface.

The tape is spiral wrapped around the handle such that the right edge embossed portion overlies the upper surface of the rubber left edge portion of the previous turn.

Other features and many attendant advantages of the invention will become more apparent upon a reading of the following detailed description together with the drawings in which like reference numerals refer to like parts throughout.

### BRIEF DESCRIPTION OF THE DRAWINGS

FIG. 1 is a perspective view of the handle of a golf club with an exemplary embodiment of the tape spiral wound around it according to the invention.

FIG. 2 is a lateral cross sectional view, partially cut away, of the thermoplastic portion of the grip tape before skiving and embossing.

FIG. 3 is a lateral cross sectional view, partially cut away, of the thermoplastic portion of FIG. 2 after skiving and embossing and applying a bottom adhesive.

FIG. 4 is a lateral cross sectional view taken on line 4-4 of FIG. 1, partially cut away, of a preferred embodiment of the tape of FIG. 1 including the thermoplastic portion of FIG. 3.

FIG. 5 is a cross sectional view, partially cut away, taken on line 5-5 of FIG. 1 showing a preferred embodiment of the overlapping wrapping of the tape on the handle.

### DETAILED DESCRIPTION OF THE INVENTION

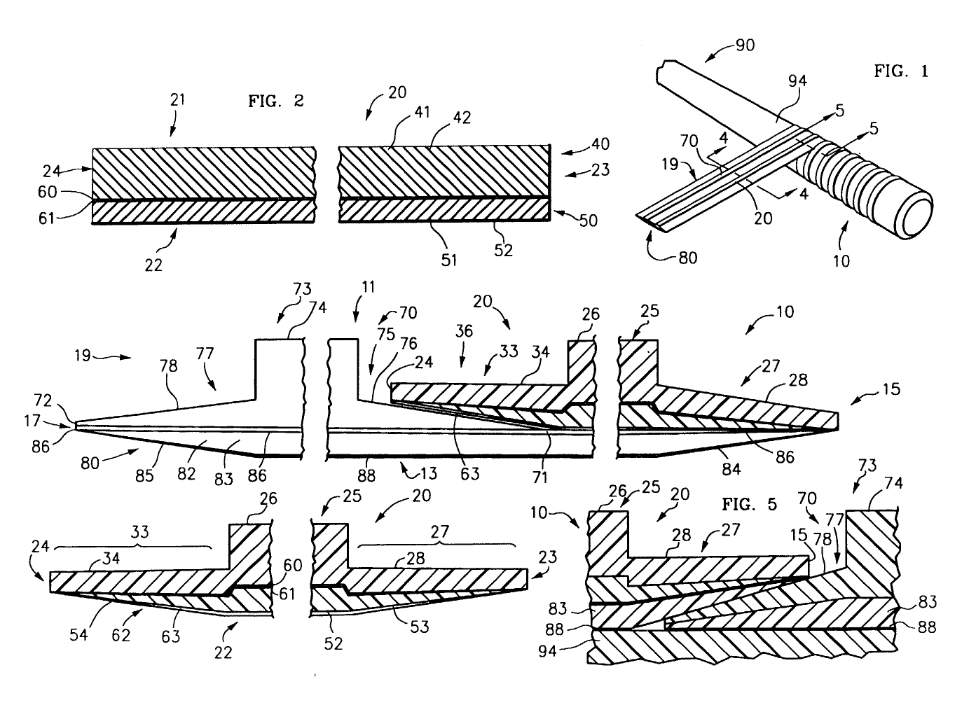

With reference now to the drawings, FIG. 1 is a perspective view of the handle 94 of a golf club 90 with an exemplary embodiment of the tape 10 spiral wound around it according to the invention. Tape 10 generally includes a top portion 19, including a thermoplastic portion 20 and a rubber 70, and a bottom portion 80.

FIG. 2 is a lateral cross sectional view, partially cut away, of thermoplastic portion 20 of grip tape 10 before skiving and embossing. Thermoplastic portion 20, an elongate strip, is rectangular in lateral cross section and has a top, 21, a bottom 22, a right edge 23, a left edge 24 and comprises an upper part 40 of thermoplastic 41, such as polyurethane 42, and a lower part 50 of cloth 51, such as felt 52, bonded to upper part 40, such as to polyurethane 42, with an adhesive 60, such as two sided tape 61. Other possible materials for thermoplastic 41 include polyurethane synthetic rubber or neoprene.

Typical dimensions of thermoplastic portion 20 for a grip tape 10 for a golf club 90 are: width, 8-16 mm; thickness of felt 52, 0.3-1.0 mm; and thickness of polyurethane 42, 0.5-1.0 mm. Cloth 51 is preferably open-pore, cushiony, and relatively inelastic, so as to prevent stretching of thermoplastic 41 to which it is bonded.

Other possible materials for cloth 51 include non-woven cloth made of nylon fiber, polyester fiber, or a combination of different kinds of fibers.

FIG. 3 is a lateral cross sectional view, partially cut away, of thermoplastic portion 20 of FIG. 2 after skiving and embossing and applying adhesive 62 to bottom 22. Thermoplastic portion 20 includes a central portion 25 having an upper surface 26, a right edge embossed portion 27 having an upper surface 28 lower than thermoplastic portion central portion upper surface 26, and a left edge embossed portion 33 having an upper surface 34 lower than thermoplastic portion central portion upper surface 26. Right edge embossed portion 27 and left edge embossed portion 33 have been embossed through pressure and/or heat, as is well-known in the art, such that right edge embossed portion 27 and left edge embossed portion 33 are denser, as shown by the double hatching, than thermoplastic portion central portion 25.

Before the embossing, felt 52 was beveled or skived to produce right bevel portion 53 and left bevel portion 54. Adhesive 62, such as two sided tape 63, is applied to bottom 22 of thermoplastic portion 20.

FIG. 4 is a lateral cross sectional view taken on line 4-4 of FIG. 1, partially cut away, of a preferred embodiment of tape 10 of FIG. 1, including thermoplastic portion 20 of FIG. 3. Tape 10 has a top 11, a bottom 13, a right edge 15 and a left edge 17. Tape 10 generally includes a top portion 19, including a thermoplastic portion 20 and a rubber 70, and a bottom portion 80. Thermoplastic portion 20 is as shown and described in FIG. 3.

Rubber 70 is in the form of an elongate strip having a right edge 71 and a left edge 72. Rubber 70 may be natural rubber, synthetic rubber such as EPDM or neoprene, or similar material that is very resilient and has a tacky surface. For a grip tape 10 for a golf club, typical rubber dimensions are: width 8-16 mm. and thickness 0.5-1.0 mm. Rubber 70 includes a central portion 73 having an upper surface 74, a right edge portion 75 having an upper surface 76 lower than rubber central portion upper surface 74, and a left edge portion 77 having an upper surface 78 lower than rubber central portion upper surface 74. Preferably, upper surfaces 76, 78 slant outwardly downward.

Thermoplastic portion 20 is connected to rubber portion 70 such as by bonding with two sided tape 63 or other means, or by just overlapping with slight tension without two-sided tape.

Rubber right edge portion 75 and thermoplastic left edge embossed portion 33 overlap one another to define an overlap 36 and are bonded to one another along the overlap, such as by bonding with two sided tape 63. In the preferred embodiment shown, left edge embossed portion 33 overlaps rubber right edge portion 75. Right edge embossed portion 27 and left edge embossed portion 33 are denser than central portion 25 and stiffer than rubber edge portions 75, 77. In this manner, right edge embossed portion 27 and left edge embossed portion 33 of thermoplastic portion 20 are very strong and stiff, such that they are not easily bent or peeled upward from edge pressure. In this manner, the softer, weaker rubber right edge portion is protected and held down. Preferably, also, thermoplastic portion left edge embossed portion upper surface 34 at left edge 24 is lower than rubber central portion upper surface 74. In this manner, rubber central portion 73 protects left edge 24 from forces that would damage it or roll it upward.

Bottom portion 80 includes cloth 82, such as felt 83 bonded to top portion 19, such as by two sided tape 86. Typical thickness of bottom felt 83 is 0.3-1.0 mm. Bottom portion felt 83 includes a skived right portion 84 and a skived left portion 85. Bottom 13 is coated with an adhesive, such as two-sided tape 88.

FIG. 5 is a cross sectional view, partially cut away, taken on line 5-5 of FIG. 1 showing a preferred embodiment of the overlapping wrapping of the tape 10 on handle 94.

Tape 10 is tensioned and spiral wrapped around handle 94 such that tape 10 flattens against any underlying surface. On each succeeding spiral, right edge embossed portion 27 at least partially overlaps upper surface 78 of rubber left edge portion 77 of the previous turn. In this manner, the softer, weaker rubber left edge portion 77 is protected and held down. Preferably, also, thermoplastic portion right edge embossed portion upper surface 28 at right edge 15 is lower than rubber central portion upper surface 74. In this manner, rubber central portion 73 protects left edge 15 from forces that would damage it or roll it upward. Preferably, the entire upper surface 28 of right edge embossed portion 27 is disposed below rubber central portion upper surface 74 of the succeeding wrap as depicted in FIG. 5.

The ends of tape 10 are secured in any appropriate manner well-known in the art.

Having described the invention, it can be seen that it provides for an improved grip tape and wrapping method for same. In the description and claims, the terms “left” and “right” have been used for convenience of description and, of course, are reversible as a whole due to symmetry.

Although a particular embodiment of the invention has been illustrated and described, various changes may be made in the form, composition, construction, and arrangement of the parts without sacrificing any of its advantages. Therefore, it is to be understood that all matter herein is to be interpreted as illustrative and not in any limiting sense, and it is intended to cover in the appended claims such modifications as come within the true spirit and scope of the invention.

I claim:

1. A grip tape for wrapping a handle comprising:
an elongate tape having a top, a bottom, a left side, and a right side; said tape including:
a top portion comprising:
a thermoplastic in the form of an elongate strip; and
a rubber in the form of an elongate strip; and
connecting means connecting said thermoplastic and said rubber.

2. The grip tape of claim 1 wherein:
said connecting means includes:
a bottom portion underlying said top portion comprising:
cloth bonded to said thermoplastic and to said rubber.

3. The grip tape of claim 1 wherein:
said connecting means includes:
bonding means bonding said thermoplastic and said rubber.

4. The grip tape of claim 1 wherein:
said thermoplastic is urethane.

5. The grip tape of claim 2 wherein:
said cloth is open-pore.

6. The grip tape of claim 2 wherein:
said cloth is felt.

7. A grip tape for wrapping a handle; said tape having a top, a bottom, a left side, and a right side; said tape comprising:
a top portion comprising:
a rubber in the form of an elongate strip having a right edge and a left edge; said rubber comprising:
a central portion having an upper surface;
a right edge portion having an upper surface lower than said rubber central portion upper surface; and
a left edge portion having an upper surface lower than said rubber central portion upper surface; and
a thermoplastic in the form of an elongate strip having a right edge and a left edge; said thermoplastic comprising:
a central portion having an upper surface;
a right edge portion having an upper surface lower than said thermoplastic central portion upper surface; and
a left edge portion having an upper surface lower than said thermoplastic central portion upper surface; wherein:
a said rubber right edge portion and said thermoplastic left edge portion overlap one another to define an overlap and are bonded to one another along the overlap.

8. The grip tape of claim 7 wherein:
said overlap has a free end having an upper surface lower than said rubber central portion upper surface.

9. The grip tape of claim 7 wherein:
said thermoplastic is urethane.

10. The grip tape of claim 7 further including:
a bottom portion underlying said top portion comprising:
cloth bonded to said thermoplastic and to said rubber.

11. The grip tape of claim 10 wherein:
said cloth is open-pore.

12. The grip tape of claim 10 wherein:
said cloth is felt.

13. A grip tape for wrapping a handle; said tape having a top, a bottom, a left side, and a right side; said tape comprising:
a top portion comprising:
a rubber in the form of an elongate strip having a right edge and a left edge; said rubber comprising:
a central portion having an upper surface;
a right edge portion having an upper surface lower than said rubber central portion upper surface; and
a left edge portion having an upper surface lower than said rubber central portion upper surface; and
a thermoplastic portion in the form of an elongate strip having a right edge and a left edge; said thermoplastic portion comprising:
a thermoplastic comprising:
a central portion having an upper surface;
a right edge embossed portion having an upper surface lower than said thermoplastic central portion upper surface; said right edge embossed portion being denser than said thermoplastic central portion; and
a left edge embossed portion having an upper surface lower than said thermoplastic central portion upper surface; said left edge embossed portion being denser than said thermoplastic central portion; wherein:
said thermoplastic left edge embossed portion overlaps said rubber right edge portion to define an overlap and is bonded to said rubber right edge portion.

14. The grip tape of claim 13 wherein:
said thermoplastic left edge has an upper surface lower than said rubber central portion upper surface.

15. The grip tape of claim 13 further including:
a bottom portion of cloth bonded to said top portion.

16. The grip tape of claim 15 wherein:
said cloth includes:
a skived right portion; and
a skived left portion.

17. The grip tape of claim 15 wherein said cloth is felt.

18. The grip tape of claim 15 wherein said bottom is coated with two-sided tape.

20. A grip tape for wrapping a handle; said tape having a top, a bottom, a left side, and a right side; said tape comprising:
a top portion comprising:
a rubber in the form of an elongate strip having a right edge and a left edge; said rubber comprising:
a central portion having an upper surface;
a right edge portion having an upper surface lower than said rubber central portion upper surface; and
a left edge portion having an upper surface lower than said rubber central portion upper surface; and
a thermoplastic portion in the form of an elongate strip having a right edge and a left edge; said thermoplastic portion comprising:
an upper part of thermoplastic; and
a lower part of cloth bonded to said thermoplastic; said thermoplastic portion including:
a central portion having an upper surface;
a right edge embossed portion having an upper surface lower than said thermoplastic portion central portion upper surface; said right edge embossed portion being denser than said thermoplastic portion central portion; and
a left edge embossed portion having an upper surface lower than said thermoplastic portion central portion upper surface; said left edge embossed portion being denser than said thermoplastic portion central portion; wherein:
said left edge embossed portion overlaps said rubber right edge portion to define an overlap and is bonded to said rubber right edge portion.

21. The grip tape of claim 20 wherein:
said cloth includes:
a skived right portion; and
a skived left portion.

22. The grip tape of claim 20 wherein:
said thermoplastic portion left edge has an upper surface lower than said rubber central portion upper surface.

23. The grip tape of claim 20 further including:
a bottom portion including:
cloth bonded to said top portion.

24. The grip tape of claim 23 wherein:
said cloth of said bottom portion includes:
a skived right portion; and
a skived left portion.

25. The grip tape of claim 23 wherein said cloth is felt.

26. The grip tape of claim 23 wherein said bottom is coated with two-sided tape.
